(19) United States
(12) Patent Application Publication
(10) Pub. No.: US 2014/0272887 A1
(43) Pub. Date: Sep. 18, 2014

(54) INTERACTIVE ASYNCHRONOUS EDUCATION

(71) Applicant: 2U, INC., Landover, MD (US)

(72) Inventor: Ian Van Tuyl, New York, NY (US)

(73) Assignee: 2U, INC., Landover, MD (US)

(21) Appl. No.: 13/795,144

(22) Filed: Mar. 12, 2013

(51) Int. Cl. G09B 5/08

(52) U.S. Cl. CPC G09B 5/08
USPC 434/350

(57) ABSTRACT

A system for asynchronous education content delivery is disclosed. A data store comprises education content associated with a course of learning and sequence data specifying an order for presentation of the content. Education content comprises video recordings of lectures, questions, and model responses. The system receives students' requests for data, queries the database in order to identify the appropriate content, and transmits the content. The system may require that a student provide input in response to a recorded prompt in order to proceed with a planned course of study. The student's inputs are made available to other students and teachers for further review and critique.

### BACKGROUND

Traditionally, teaching has taken place in a setting where both teachers and students gather in the same place at the same time. For example, a grammar school teacher may discuss topics with a classroom full of students seated before him. Similarly, a college professor may lecture to her students congregated in a lecture hall.

In these traditional teaching settings, students learn not only from the lectured materials but also from the interactions between the teacher and fellow students. The teacher or professor poses questions to the class and students in the class volunteer responses. The process is interactive with the teacher or professor responding to the students' answers or responses. Frequently, the teacher or professor responds to a student's input with an explanation or comment followed by further questions for the students. The teacher and students engage in a dialogue whereby students learn through critical thinking about the issues raised during the interchange. Such a process is sometimes referred to as the Socratic teaching method. Not only do the students in the class learn from the teacher's comments and questions, but also from the responses by their fellow classmates. Students in the class remain engaged in the conversation knowing that they may be called upon to take part in the dialogue.

### SUMMARY

Applicants have developed computer-implemented systems and methods for asynchronous interactive teaching. The disclosed systems and methods replicate the interactive classroom learning experience, but allow for the experience to take place asynchronously and at the convenience of the students. Students are presented with recorded lectures, related questions, and model student responses to questions, all at the convenience of the student. Students may be required to provide input such as responses to questions in order to continue with a course of learning. Student inputs may be made available for consideration by others including teachers and other students.

In an exemplary embodiment, education content, such as, for example, recordings of educational subject matter are stored in a data store. The recordings may contain, for example, video recordings of portions of lectures presented by a teacher or professor. Recordings of questions relevant to the recorded lectured materials are also stored in a data store. For example, questions that the teacher or professor would normally present to students if the lecture were given in a classroom may be recorded and stored in the data store. In addition, recorded responses to various of the recorded questions are stored in the data store. For example, responses by students or former students to the various questions are reviewed and placed in the data store for review by current students. The recorded responses may be model responses recorded at the direction of the course instructor.

In an example embodiment, the data store may still further comprise sequence data that specifies relationships between the recorded lecture content, recorded question content, and recorded answers. For example, the sequence data may specify that a particular recorded question be presented to a user of the system after a particular recorded lecture segment. Similarly, the sequence data may specify that a particular recorded response be presented to a user of the system after a particular recorded question is presented. The sequence data may still further specify that input is expected from a user of the system after a particular content segment is presented to the user. For example, the sequence data may specify that the student is required to upload a video recording response to a presented question.

In an example embodiment, the data store may further comprise student data for student users of the system. For example, the student data may comprise administrative data regarding the student such as biographical information and registration data. The student data may further comprise data regarding the particular student's progress in a course of study. For example, the student data may comprise data indicating which portions of a course the particular student has downloaded, which portions of a course the particular student has actually reviewed, and which requests for user input or questions the particular student has responded to. The inputs or responses from the students are likewise stored in the data store.

In an example embodiment, an education content server is communicatively coupled with the data store. The education content server is likewise accessible, perhaps via a network such as the Internet, to client devices. The education content server receives requests for education content from the client devices and queries the sequence data and education data to determine the appropriate content to provide to the requesting student. The education content server is also adapted to receive inputs from students, including video and audio recordings, which are then stored in the data store and thereafter made available to other students and teachers.

According to one example scenario, the education content server may receive a request from a student via the network for a recorded lecture segment. The requested lecture segment may be a segment in a successive series of lecture segments in a planned course of study as specified by the sequence data. In response to the request, the education content server queries the data store for the requested content. In an example scenario, the education content server may query the sequence data in order to determine the content that should be provided to the student in response to the request. In another example scenario, the request may designate the particular education content that is requested. The education content server retrieves the appropriate education content, which may be, for example a video recording of a portion of a lecture.

The education content server then transmits the retrieved education content to the student that requested the content. In an example scenario, the content is transmitted over a network such as the Internet to a client device operated by the student. The education content server updates the student data to reflect that the data was communicated to the particular student.

The education content server may next determine that the student has completed reviewing the transmitted content. For example, the education content server may receive a request via the network from the student for the next content designated in the course of study. The request may be for a specific item or may specify only that the next item in the curriculum be provided to the student. The education content server identifies the particular content, which may involve querying the sequence data, and retrieves the content from the data store. In an example scenario, the content retrieved from the data store is a recorded request for student input. For example, the retrieved content may be a video recording of a question from a teacher. The recorded request for input is transmitted to the student. The education content server updates the student data to reflect that the data was communicated to the particular student.

The education content server may then determine that the student has completed reviewing the recorded request for input. For example, the education content server may receive an automated response when the student completes reviewing the previously transmitted content. In an alternative scenario, the education content server may receive a request via the network from the student for the next content designated in the course of study. The request may be for a specific item, such as a recorded response to the previously transmitted question, or may specify only that the next item in the curriculum be provided to the student. The education content server identifies the particular content, which may involve querying the sequence data, and retrieves the content from the data store. In an example scenario, the content retrieved from the data store is a recorded response to a previously transmitted request for input. For example, the retrieved recorded response may be a response to the question prepared by another student or model response created in connection with the curriculum and intended to be viewed as a part of the course of study. The recorded response is transmitted to the student. The education content server updates the student data to reflect that the data was communicated to the particular student.

The education content server may next determine that the student has completed reviewing the recorded response to the previously transmitted request for input. For example, the education content server may receive a request via the network from the student for the next content designated in the course of study. The request may be for a specific item or may specify only that the next item in the curriculum be provided to the student. The education content server identifies the particular content, which may involve querying the sequence data, and retrieves the content from the data store. In an example scenario, the content retrieved from the data store is another recorded request for input from a student. For example, the retrieved content may be a video of a question previously recorded by the teacher and which, according to the data in the sequence data, is appropriate for the particular student to review during his/her course of study. The recorded request for input is transmitted to the student. The education content server updates the student data to reflect that the data was communicated to the particular student.

In an example scenario, the education content server monitors for an input in response to a request for student input. For example, the education content server monitors for receipt of a video recording of a response from the student to the question that was presented. In an example embodiment, the education content server may deny further requests from the particular student until after an input is received from the student.

Continuing with an example scenario, upon receipt of a response from the student, the education content server updates the student data for the particular student to reflect that the student has made his/her submission. The education content server stores the actual submission from the student as well.

The education content server may then make the submission from the student available for others to review. For example, in one potential scenario, the submission is made available to a teacher or supervisor for review. In another potential scenario, the submission may be made available to other students that are following the same or a similar course of study.

The education content server may continue to receive further requests from the particular student in order to complete a particular course of study. For example, requests may be received for additional lecture materials, requests for input, previously recorded responses to input, etc.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

The foregoing summary and the following additional description of the illustrative embodiments may be better understood when read in conjunction with the appended drawings. It is understood that potential embodiments of the disclosed systems and methods are not limited to those depicted.

FIG. 1 is a network diagram of an illustrative interactive asynchronous education system.

FIG. 2 is a diagram depicting functional components of an illustrative interactive asynchronous education system.

FIG. 3 is a flow diagram of a process for interactive asynchronous education.

FIG. 4 is a block diagram of an exemplary computing environment that may be used to implement the systems and methods described herein.

### DETAILED DESCRIPTION OF ILLUSTRATIVE EMBODIMENTS

Example Computing Arrangement

FIG. 1 illustrates an exemplary computing network 100 suitable for interactive asynchronous education. Interactive education content service 120 is adapted to receive and maintain educational content such as recorded lectures and recorded requests for inputs, i.e., recorded questions. Education content service 120 is further adapted to process requests for educational content, determine the appropriate content for transmission according to a course of study, and to transmit the appropriate content.

In an example embodiment, service 120 comprises servers 140 which are communicatively coupled with data stores 142. Servers 140 may comprise any computing device that is adapted to perform the functionality as described herein including, for example, communicating with external data sources 112 to receive education content such as recordings of lectures and questions, store the data, and to query the data stores in order to identify the correct educational content to be transmitted to a particular student as described herein. Servers 140 are communicatively coupled, perhaps using a computing network, with data stores 142. Data stores 142 maintain any data that may be needed to support the functionality described herein. For example, data stores 142 may be employed to store education content such as recorded lecture segments, recorded questions that are intended to be interspersed with the lectured segments, recorded responses to questions (some which may be model responses), and sequence data that identifies courses of study and the order that lecture segments, questions, and responses are to be presented during a course of study. Data stores 142 may comprise any data storage technology that may be adapted to provide the functionality described herein. Any number of servers 140 and data stores 142 may be used to provide education content services as described herein.

Service 120 is adapted to receive education content data from sources 112a-c via communications network 150. Sources 112a-c may be any source from which education content may be received including, for example, computing machines associated with education providers such as universities, high schools, or other entities that create education content. The format of the data received may be any type that is suitable for use as described herein. For example, video recordings of lectures, questions, and approved responses may be received in .wav format or any other suitable format.

Users may employ computing devices 110a-e to interface with service 120 via communications network 150. Computing devices 110a-e may be used to interface with service 120 in order to, for example, request education content such as lectures, teacher questions, and previously recorded answers to questions. Further devices 110a-e may be used to input data such as responses to questions transmitted by service 120 to students. Computing devices 110a-e may be any type of device that is operable to communicate with service 120. For example, computing devices 110a-e may be desktop computers, laptop computers, wireless phones, personal digital assistants, tablet computers, media players, etc. While only five devices are illustrated in FIG. 1, it is understood that service 120 may be accessed via any number of computing devices 110a-e. Computing devices 110a-e may employ any technology that is suitable to interface with service 120 including, for example, Web browser and Internet technology.

Service 120 is accessible via communications network 150. Communications network 150 may be any type of network that is suitable for providing communications between computing devices 110a-e and service 120. Moreover, communications network 150 may comprise a combination of discrete networks which may use different technologies. For example, communications network 150 may comprise local area networks (LANs), wide area networks (WAN's), cellular networks, or combinations thereof. Communications network 150 may comprise wireless, wireline, or combination thereof. In an exemplary embodiment, communications network 150 comprises the Internet and may additionally comprise any networks adapted to communicate with the Internet.

Computing arrangement 100 may employ a host of network topologies such as client/server, peer-to-peer, or hybrid architectures. The “client” is a member of a class or group that uses the services of another class or group to which it is not related. Thus, in computing, a client is a process (i.e., roughly a set of instructions or tasks) that requests a service provided by another program. The client process utilizes the requested service without having to “know” any working details about the other program or the service itself. In a client/server architecture, particularly a networked system, a client is usually a computing device, such as one of devices 110a-e that accesses shared network resources provided by another computer (i.e., a server). A server, such as device 140, is typically a remote computer system accessible over a remote network such as the Internet. The client process may be active in a first computer system, and the server process may be active in a second computer system, communicating with one another over a communications medium and allowing multiple clients to take advantage of the information-gathering capabilities of the server.

Clients and servers communicate with one another utilizing the functionality provided by a protocol layer. For example, Hypertext-Transfer Protocol (HTTP) is a common protocol that is used in conjunction with the World Wide Web (WWW) or, simply, the “Web.” Typically, a computer network address such as a Uniform Resource Locator (URL) or an Internet Protocol (IP) address is used to identify the server or client computers to each other. Communication among computing devices is provided over a communications medium. In particular, the client and server may be coupled to one another via TCP/IP connections for high-capacity communication.

FIG. 2 depicts a block diagram illustrating example logical components of an illustrative service 120 for providing asynchronous access to education content. In the example embodiment depicted in FIG. 2, education content database 210 represents the functional database operations performed by service 120 in connection with storing, maintaining, and accessing education content data. Education content database 210 comprises any data that may be presented in connection with a class, curriculum, or other course of study. Education content database 210 comprises recorded lectures or lecture segments that may be presented during a course of study. For example, education content database 210 may comprise lecture segments for a high school history class, a college physics class, a law school real property class, a continuing professional education class, or any other type of course of study. Education content database 210 further comprises requests for input or questions that correspond to the lecture content. For example, the database may comprise recorded questions that are typically posed to students taking a particular course of study. The questions may be intended to be interspersed in a particular order with lecture content. Education content database 210 may further comprise recorded responses to questions. For example, the recorded responses may be model responses that have been reviewed and approved for review by students. The recorded responses may be “canned” or model responses that were strategically included so as to teach a particular point. The recorded responses may be actual responses from students in a particular course. The lecture segments, requests for inputs, and responses may be in any format that is suitable for storage, transmission, and display. For example, the data may be formatted as .avx or .wav files or any similar format. The lecture segments, recorded questions, and responses may be as long or as short as determined best for presenting a course. The education content may comprise education content for a plurality of different courses and organizations.

Sequence data database 212 represents the functional database operations performed by service 120 in connection with storing, maintaining, and accessing sequence data. Sequence data comprises data that specifies for courses of study the particular education content, questions, and responses that are to be presented and the sequence that they are to be presented. For example, sequence data may specify for a particular law school class on real property, that a first lecture segment is to be presented, followed by a particular question, followed by a particular model response, etc. The sequence data further specifies the particular locations where student input is required. For example, the sequence data may specify that a particular question is to be presented and, thereafter a student input is required before further content may be made available to the student. The sequence data may comprise data specifying courses of study for a plurality of different courses and organizations.

Student data database 214 represents the functional database operations performed by service 120 in connection with storing, maintaining, and accessing student data. Student data comprises any data relating to particular students that is needed to provide functionality as described herein. In an example, embodiment, student data may comprise administrative data regarding students such as name, address, etc. The student data may further comprise data regarding the courses that the particular student is currently registered to participate in. The student data may still further comprise data regarding the progress that particular students have made in a course. For example, the student data may specify that a student has reviewed particular lectures, questions, and model responses, and or provided particular inputs. The student data may further specify that the student has yet to complete other components of a particular course of study. The student data may further comprise inputs that are provided by the student in connection with a course of study. For example, the student data may comprise the video recordings or text inputs that a student made in connection with taking a course. The students' inputs may be made available to professors for review and grading and may be made available to other students for review, evaluation, and critique.

Education content server 220 acts as an interface to service 120 and provides, with the databases, 210-214 the functionality as described herein. Education content server 220 may comprise functionality for serving data corresponding to a user interface such as, for example, web pages.

Administrative server 222 provides administrative functionality to service 120. In an example embodiment, administrative server 222 provides an interface to add education content such as lectures, questions, and model responses to the database. Administrative server 222 may further provide functionality that allows for teachers to access content such as student responses to recorded requests for input and to enter feedback regarding the student responses. For example, the administrative server 222 may provide functionality that allows a teacher to enter a grade and comments regarding a student's response.

FIG. 3 depicts a flow chart of example processing performed in an interactive education content service 120. As shown, at block 310, education content server 220 receives a request from a student via network 150 for a recorded lecture segment. The request may have originated from any of devices 110. In an example scenario, the student may have previously registered for a particular course of study such as, for example, a college history class or law school class on real property. The request received from the student may be a request for the next lecture segment associated with the particular class.

At block 312, and in response to the request, education content server 220 queries the data store (210-214) for the requested content. In an example scenario, education content server 220 may query sequence data 212 in order to determine the content that should be provided to the student in response to the request. For example, education content server 220 may query sequence database 212 and student database 214 in order to determine the next education content item that should be provided to the student based upon the student's progress in the course of study. In another example scenario, the request received at education content server 220 may designate the particular education content that is requested. After determining which education content is appropriate for the particular student, education content server 220 retrieves the identified education content from education content database 210. The retrieved content may be any that is suitable for use in an education setting and may take any suitable format including text, audio, and/or video. In an example scenario, the retrieved education content may be, for example, a video recording of a portion of a lecture.

At step 314, education content server 220 transmits the retrieved education content to the student that requested the content via network 150. In the scenario wherein the education content is a recorded portion of a lecture, the portion of the recorded lecture is transmitted. Education content server 220 updates student data database 214 to reflect that the data was communicated to the particular student. The transmitted data is received at any one of devices 110 operated by the student.

At step 316, education content server 220 may determine that the student has completed reviewing the transmitted content. For example, education content server 220 may receive an automated response via network 150 when the student completes reviewing the previously transmitted content. In an alternative scenario, education content server 220 may receive a request via network 150 from the student for the next content designated in the course of study. The request may be for a specific item or may specify only that the next item in the curriculum be provided to the student. At step 318, education content server 220 identifies particular content to be provided to the student. The process may involve querying sequence data database 212 and student data 214. For example, in an example scenario, education content server 220 may query student data 214 in order to determine which program the particular student is undertaking and the segment of information that was most recently reviewed by the particular student. Education content server 220 may then query sequence data 212 in order to identify the appropriate segment to be provided to the student given the current progress of the student in the course of study. The identified content is then retrieved from education content database 210. In an example scenario, the content retrieved from the data store is a recorded request for student input or response. The retrieved content may be any suitable for use in an education setting and may take any suitable format including text, audio, and/or video. In an example scenario, the retrieved education content may be, for example, a video recording of a question presented by a teacher or professor.

At step 320, education content server 220 transmits the retrieved request for input to the student via network 150. In the scenario wherein the retrieved request for input is a video of a recording of a question, the video is transmitted. Education content server 220 updates the student data database 214 to reflect that the data was communicated to the particular student. The transmitted data is received at any one of devices 110 operated by the student.

At step 322, education content server 220 may determine that the student has completed reviewing the transmitted request for input. For example, education content server 220 may receive an automated response via network 150 when the student completes reviewing the previously transmitted content. In an alternative scenario, education content server 220 may receive a request via network 150 from the student for the next content designated in the course of study. The request may be for a specific item, such as a recorded response to the previously transmitted question, or may specify only that the next item in the curriculum be provided to the student.

At step 324, education content server 220 identifies the particular content to be provided to the student. The process may involve querying sequence data database 212 and student data 214. For example, in an example scenario, education content server 220 may query student data 214 in order to determine which program the particular student is undertaking and the latest segment of information that was reviewed by the particular student. Education content server 220 may then query sequence data 212 in order to identify the appropriate segment to be provided to the student given the current progress of the student in the course of study. The identified content is then retrieved from education content database 210. In an example scenario, the content retrieved from education content database 210 is a recorded response to a previously transmitted request for student input or response. For example, the retrieved recorded response may be a response to the question prepared by another student or model response created in connection with the curriculum and intended to be viewed as a part of the course of study. The retrieved content may be any suitable for use in an education setting and may take any suitable format including text, audio, and/or video. In an example scenario, the retrieved response may be, for example, a video recording. In still another embodiment the retrieved response may comprise a plurality of responses prepared by several different persons.

At step 326, education content server 220 transmits the retrieved recorded response to the student via network 150. Education content server 220 updates the student data database 214 to reflect that the data was communicated to the particular student. The transmitted data is received at any one of devices 110 operated by the student.

At step 328, education content server 220 may determine that the student has completed reviewing the recorded response to the previously transmitted request for input. For example, education content server 220 may receive an automated response via network 150 when the student completes reviewing the previously transmitted content. In an alternative scenario, education content server 220 may receive a request via network 150 from the student for the next content designated in the course of study. The request may be for a specific item, such as another recorded question that is next in a course of study, or may specify only that the next item in the curriculum be provided to the student.

At step 330, education content server 220 identifies the particular content to be provided to the student. The process may involve querying sequence data database 212 and student data 214. For example, in an example scenario, education content server 220 may query student data 214 in order to determine which program the particular student is undertaking and the latest segment of information that was reviewed by the particular student. Education content server 220 may then query sequence data 212 in order to identify the appropriate segment to be provided to the student given the current progress of the student in the course of study. The identified content is then retrieved from education content database 210. In an example scenario, the content retrieved from education content database 210 is another recorded request for input or response from a student, i.e., another question. For example, the retrieved content may be a video of a question previously recorded by the teacher and which, according to the data in the sequence data, is appropriate for the particular student to review during his/her course of study. In another example scenario, the request for input may be a request that the student provide a critique of the recorded response that the student just recently reviewed.

At step 332, education content server 220 transmits the retrieved recorded request for response to the student via network 150. Education content server 220 updates the student data database 214 to reflect that the data was communicated to the particular student. The transmitted data is received at any one of devices 110 operated by the student.

At step 334, education content server 220 may determine that the student has input a response to the request for input transmitted at step 332. In an example scenario, education content server 220 may be monitoring for student input and receives an input such as, for example, a text input response, an input selection from a provided set of responses, and/or a video recording of a response from the student to the question that was presented in the previously transmitted request for input. In another example scenario, the received input may be a critique of the recently reviewed recorded response. In an example embodiment, education content server 220 may deny or not process further requests from the particular student until after an input is received from the student.

At step 336, upon receipt of a response from the student, education content server 220 updates student data database 214 to reflect that the student has made his/her submission and stores the actual submission. The submission may be any type of data responsive to the request for input that was previously transmitted. For example, the received input may be a video recorded response, an audio recording of a response, a document containing a typed response, or a selection from a system provided list of possible responses.

At step 340, education content server 220 may make the student's submission available for others to review. For example, in one potential scenario, education content server 220 may update education content database 210 to indicate that the submission from the student is available for other students to review and possibly critique. In an example scenario, a student other than the student that entered the input may thereafter access the received response and enter feedback regarding the submission. Education content server 220 may also update education content database 210 to indicate that the received student input is available for review and comment by an instructor. In an example scenario, a teacher or instructor may thereafter access administrative functionality 222 to access the received response and enter feedback regarding the submission. The student, as part of his/her course of study may subsequently retrieve the feedback from either the teacher or other students and, in some embodiments, submit a revised submission in view of the instructor feedback. In an example scenario wherein the input from the student is a critique of another student's response, the critique may be transmitted to the other student or possibly to a teacher or professor.

Education content server 220 may continue to receive further requests from the particular student in order to complete a particular course of study. In an example scenario, in response to the next request from the student for further content in the course of study, server 220 may retrieve and transmit a model answer or the answer of other students to the question to which the student has just completed submitting a response. This allows the student to learn from having answered the question herself as well as from reviewing the model answer and/or answers from other students. In variation of this scenario, server 220, upon receiving a further request, may retrieve and transmit to the student direction to review multiple responses to the question to which the student has given a response. Server 220 may further require that the student input another response to the question after having reviewed the model response and/or responses of other students. This further response may be made available to other students and the instructor according to the process described above.

In yet a further variation, the student may be presented with critiques or feedback regarding their response to a question and thereafter be required to submit a new response. In another example scenario, in response to receiving an input from the student, education content server 220 may receive and process requests for testing materials.

Further requests may be received for additional lecture materials, requests for input, previously recorded responses to input, etc. The requests may be received in any order so as to achieve the desired progress through a designed curriculum or course of study.

Example Computing Environment

FIG. 4 depicts a block diagram of an exemplary computing system 1000 that may be used to implement the systems and methods described herein. For example, the computing system 1000 may be used to implement the education content service 120 as well as any of devices 140, 110a-e and 112a-c. The computing system 1000 may be controlled primarily by computer readable instructions that may be in the form of software. The computer readable instructions may include instructions for the computing system 1000 for storing and accessing computer readable instructions themselves. Such software may be executed within a central processing unit (CPU) 1010 to cause the computing system 1000 to perform the processes or functions associated therewith. In many known computer servers, workstations, personal computers, or the like, the CPU 1010 may be implemented by micro-electronic chips CPUs called microprocessors.

In operation, the CPU 1010 may fetch, decode, and/or execute instructions and may transfer information to and from other resources via a main data-transfer path or a system bus 1005. Such a system bus may connect the components in the computing system 1000 and may define the medium for data exchange. The computing system 1000 may further include memory devices coupled to the system bus 1005. According to an example embodiment, the memory devices may include a random access memory (RAM) 1025 and read only memory (ROM) 1030. The RAM 1025 and ROM 1030 may include circuitry that allows information to be stored and retrieved. In one embodiment, the ROM 1030 may include stored data that cannot be modified. Additionally, data stored in the RAM 1025 typically may be read or changed by CPU 1010 or other hardware devices. Access to the RAM 1025 and/or ROM 1030 may be controlled by a memory controller 1020. The memory controller 1020 may provide an address translation function that translates virtual addresses into physical addresses as instructions are executed.

In addition, the computing system 1000 may include a peripherals controller 1035 that may be responsible for communicating instructions from the CPU 1010 to peripherals, such as, a printer 1040, a keyboard 1045, a mouse 1050, and data a storage drive 1055. The computing system 1000 may further include a display 1065 that may be controlled by a display controller 1063. The display 1065 may be used to display visual output generated by the computing system 1000. Such visual output may include text, graphics, animated graphics, video, or the like. The display controller 1063 may include electronic components that generate a video signal that may be sent to the display 1065. Further, the computing system 1000 may include a network adaptor 1070 that may be used to connect the computing system 2000 to an external communication network such as the network 150, described above in FIG. 1.

Accordingly, applicants have disclosed exemplary embodiments of systems and methods for asynchronous education content delivery. The disclosed systems and methods replicate the interactive classroom learning experience, but allow for the experience to take place asynchronously and at the convenience of the students. Students are presented with recorded lectures, related questions, and model student responses to questions, all at the convenience of the student. Students may be required to provide input such as responses to questions in order to continue with a course of learning. Student inputs may be made available for consideration by others including teachers and other students. Additionally, students may review the responses of other students or, perhaps, model responses to the same questions that the student may have been required to consider and respond to.

It will be appreciated that while illustrative embodiments have been disclosed, the scope of potential embodiments is not limited to those explicitly set out. For example, while the system has been described with reference to particular scenarios wherein a particular sequence of lecture data, questions, and responses was described, the envisioned embodiments extend beyond a particular sequence of types of education content being delivered.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Those skilled in the art will appreciate that the disclosed embodiments may be provided as a subscription web based solution that anyone with an internet connection may log on and begin using the system. The potential embodiments may be developed and programmed in any web based technology platform. Alternatively, a potential embodiment may be implemented as a standalone application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented education method, comprising:
transmitting to a first student a first educational recording;
transmitting to the first student a first recorded request for student response;
transmitting to the first student at least one recorded response to the first recorded request for student response;
transmitting to the first student a second recorded request for student response;
determining whether the first student has submitted a response to the second recorded request for student response; and
upon receiving from the first student a response to the second recorded request for student response,
making the response from the first student available for access by other than the first student.

2. The computer-implemented education method of claim 1, wherein transmitting to a first student a first educational recording comprises transmitting a video recording of a portion of a lecture.

3. The computer-implemented education method of claim 1, wherein transmitting to the first student a first recorded request for student response comprises transmitting a video recording of a question.

4. The computer-implemented education method of claim 1, wherein transmitting to the first student a recorded response to the first recorded request for student response comprises transmitting a video recording of a response provided by other than the first student.

5. The computer-implemented education method of claim 1, wherein transmitting to the first student at least one recorded response to the first recorded request for student response comprises transmitting to the first student a plurality of recorded responses to the first recorded request for student response.

6. The computer-implemented education method of claim 1, wherein transmitting to the first student a second recorded request for student response comprises transmitting a video recording of a question.

7. The computer-implemented education method of claim 1, wherein determining whether the first student has submitted a response to the second recorded request for student response comprises delaying processing of requests from the first student for educational content until receipt of a response to the second recorded request for student response.

8. The computer-implemented education method of claim 1, further comprising accepting from the first student a request for further educational materials upon receiving from the first student a response to the second recorded request for student response.

9. The computer-implemented education method of claim 8, wherein accepting from the first student a request for further educational materials comprises receiving from the first student a request for recorded video.

10. The computer-implemented education method of claim 9, wherein accepting from the first student a request for further educational materials comprises receiving from the first student a request for testing materials.

11. The computer-implemented education method of claim 8, further comprising transmitting to the user requested further educational materials.

12. The computer-implemented education method of claim 1, wherein making the response from the first student available for access by other than the first student comprises making the response from the first student available for review by an instructor.

13. The computer-implemented education method of claim 1, wherein making the response from the first student available for access by other than the first student comprises making the response from the first student available for review to other students.

14. The computer-implemented method of claim 1, further comprising transmitting to the first student instructions to review recorded responses to the second recorded request for student responses created by other than the first student.

15. The computer-implemented method of claim 14, further comprising transmitting to the first student instructions to provide a second response to the second recorded request for student responses.

16. The computer-implemented education method of claim 1, wherein transmitting to the first student a second recorded request for student response comprises transmitting to the first student a request for a critique of a recorded response to the first recorded request for student response.

17. The computer-implemented education method of claim 16, wherein receiving from the first student a response to the second recorded request for student response comprises receiving input providing a critique of a recorded response to the first recorded request for student response.

18. The computer-implemented education method of claim 17, further comprising communicating the critique of a recorded response to at least one other person.

19. The computer-implemented education method of claim 18, wherein communicating the critique of a recorded response to at least one other person comprises communicating the critique to students.

20. The computer-implemented education method of claim 18, wherein communicating the critique of a recorded response to at least one other person comprises communicating the critique to a professor.

21. The computer-implemented education method of claim 1, wherein transmitting to the first student a second recorded request for student response comprises transmitting to the first student a request for a response to a recorded question.

22. The computer-implemented education method of claim 1, wherein receiving from the first student a response to the second recorded request for student response comprises receiving input providing a recorded video response to the recorded question.

23. The computer-implemented education method of claim 22, further comprising communicating the recorded video response to at least one other person.

24. The computer-implemented education method of claim 23, wherein communicating the recorded video response to at least one other person comprises communicating the recorded video response to students.

25. The computer-implemented education method of claim 23, wherein communicating the recorded video response to at least one other person comprises communicating the recorded video response to a professor.

26. A computing system, comprising:
a computing processor;
computing memory communicatively coupled with the computing processor, the computing memory having computer executable instructions stored therein that cause the computing system to perform operations, comprising:
transmitting to a first student a first educational recording;
transmitting to the first student a first recorded request for student response;
transmitting to the first student at least one recorded response to the first recorded request for student response;
transmitting to the first student a second recorded request for student response;
determining whether the first student has submitted a response to the second recorded request for student response; and
upon receiving from the first student a response to the second recorded request for student response,
making the response from the first student available for access by other than the first student.

27. Computer readable storage medium having stored thereon computer executable instructions that cause a computing system to perform operations comprising:
transmitting to a first student a first educational recording;
transmitting to the first student a first recorded request for student response;
transmitting to the first student at least one recorded response to the first recorded request for student response;
transmitting to the first student a second recorded request for student response;
determining whether the first student has submitted a response to the second recorded request for student response; and
upon receiving from the first student a response to the second recorded request for student response,
making the response from the first student available for access by other than the first student.
